(19) United States
(12) Patent Application Publication
(10) Pub. No.: US 2026/0280589 A1
(43) Pub. Date: Sep. 17, 2026

(54) TRANSCEIVER INCLUDING PROGRAMMABLE SELF-INTERFERENCE CANCELLER FOR FULL-DUPLEX AND TIME DIVISION DUPLEX MODES

(71) Applicant: QUALCOMM Incorporated, San Diego, CA (US)

(72) Inventors: Li LIU, San Diego, CA (US); Seyyed Hassan MOUSAVI, Laguna Niguel, CA (US)

(21) Appl. No.: 19/076,581

(22) Filed: Mar. 11, 2025

(51) Int. Cl. H04B 1/00; H04B 1/16; H04L 5/14

(52) U.S. Cl. CPC H04B 1/0078; H04B 1/163; H04L 5/1469

(57) ABSTRACT

A wireless communication apparatus comprising: a power amplifier (PA); a transmit coupler including a first input port coupled to an output of the PA, a first coupled port, and a first isolated port; a self-interference (SI) canceller; a first switching device coupled between the first coupled port of the transmit coupler and an input of the SI canceller; a low noise amplifier (LNA); a receive coupler including a transmitted port coupled to an input of the LNA, a coupled port, and an isolated port; and a second switching device coupled between an output of the SI canceller and the coupled port of the receive coupler.

### FIELD

This disclosure relates generally to transceivers, and in particular, to a transceiver including programmable self-interference (SI) canceller for full-duplex (FD) and time division duplex (TDD) modes of operations.

### BACKGROUND

A transceiver may transmit radio frequency (RF) signals and receive RF signals in accordance with various modes of operation. One mode of operation may include time division duplex (TDD) mode of operation where the transmission of a transmit RF signal does not overlap in time with the reception of a receive RF signal. Another mode of operation may include a full-duplex (FD) mode of operation where the transmission of a transmit RF signal may occur simultaneous with a reception of an RF signal, where the transmit and receive RF signals may use the same frequency band, overlapping frequency bands, or close frequency bands (e.g., within five (5) percent bandwidth of each other).

### SUMMARY

The following presents a simplified summary of one or more implementations in order to provide a basic understanding of such implementations. This summary is not an extensive overview of all contemplated implementations, and is intended to neither identify key or critical elements of all implementations nor delineate the scope of any or all implementations. Its sole purpose is to present some concepts of one or more implementations in a simplified form as a prelude to the more detailed description that is presented later.

An aspect of the disclosure relates to a wireless communication apparatus. The wireless communication apparatus includes: a power amplifier (PA); a transmit coupler including a first input port coupled to an output of the PA, a first coupled port, and a first isolated port; a self-interference (SI) canceller; a first switching device coupled between the first coupled port of the transmit coupler and an input of the SI canceller; a low noise amplifier (LNA); a receive coupler including a transmitted port coupled to an input of the LNA and a coupled port; and a second switching device coupled between an output of the SI canceller and the coupled port of the receive coupler.

Another aspect of the disclosure relates to a transceiver. The transceiver includes: a power amplifier configured to generate a transmit radio frequency (RF) signal; a transmit coupler configured to route the transmit RF signal to a transmit antenna, wherein the transmit coupler is configured to be selectively enabled to generate a first sampled transmit RF signal in accordance with a first mode of operation, and wherein the transmit coupler is configured to be selectively disabled in accordance with a second mode of operation; a self-interference (SI) canceller configured to generate a leaked transmit cancelling RF signal based on the first sampled transmit RF signal; and a receive coupler configured to route a receive RF signal from a receive antenna to a low noise amplifier (LNA), wherein the receive coupler is configured to substantially cancel out a leaked portion of the transmit RF signal using the leaked transmit cancelling RF signal.

Another aspect of the disclosure relates to a method. The method includes: routing a transmit RF signal to a transmit antenna; generating a first sampled transmit RF signal in accordance with a first mode of operation; not generating the first sampled transmit RF signal in accordance with a second mode of operation; generating a leaked transmit cancelling RF signal based on the first sampled transmit RF signal; and substantially cancelling out a leaked portion of the transmit RF signal received via a receive antenna using the leaked transmit cancelling RF signal.

Another aspect of the disclosure relates to an apparatus. The apparatus includes: means for routing a transmit RF signal to a transmit antenna; means for generating a first sampled transmit RF signal in accordance with a first mode of operation; means for not generating the first sampled transmit RF signal in accordance with a second mode of operation; means for generating a leaked transmit cancelling RF signal based on the first sampled transmit RF signal; and means for substantially cancelling out a leaked portion of the transmit RF signal received via a receive antenna using the leaked transmit cancelling RF signal.

Another aspect of the disclosure relates to a wireless communication apparatus. The wireless communication apparatus includes: a power amplifier (PA); a first transmit coupler coupled to an output of the PA, the first transmit coupler having a first level of coupling; a second transmit coupler coupled to the output of the PA, the second transmit coupler having a second level of coupling different than the first level of coupling; a low noise amplifier (LNA); a receive coupler coupled to an input of the LNA; and a self-interference cancellation circuit selectively coupled to the second transmit coupler and selectively coupled to the receive coupler.

To the accomplishment of the foregoing and related ends, the one or more implementations include the features hereinafter fully described and particularly pointed out in the claims. The following description and the annexed drawings set forth in detail certain illustrative aspects of the one or more implementations. These aspects are indicative, however, of but a few of the various ways in which the principles of various implementations may be employed and the description implementations are intended to include all such aspects and their equivalents.

### BRIEF DESCRIPTION OF THE DRAWINGS

FIG. 1 illustrates a block diagram of an example wireless communication system in accordance with an aspect of the disclosure.

FIG. 2 illustrates a block diagram of an example transceiver in accordance with another aspect of the disclosure.

FIG. 3 illustrates a block diagram of an example radio frequency front end (RFFE) in accordance with another aspect of the disclosure.

FIG. 4 illustrates a block diagram of an example self-interference cancellation circuit in accordance with another aspect of the disclosure.

FIG. 5 illustrates a block diagram of another example transceiver in accordance with another aspect of the disclosure.

FIG. 6 illustrates a flow diagram of an example method of cancelling a leaked portion of a transmit RF signal into a receiver in accordance with another aspect of the disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts. The term “substantially” means that the associated parameter may not be exact as indicated but accounts for some variation due to specified tolerances.

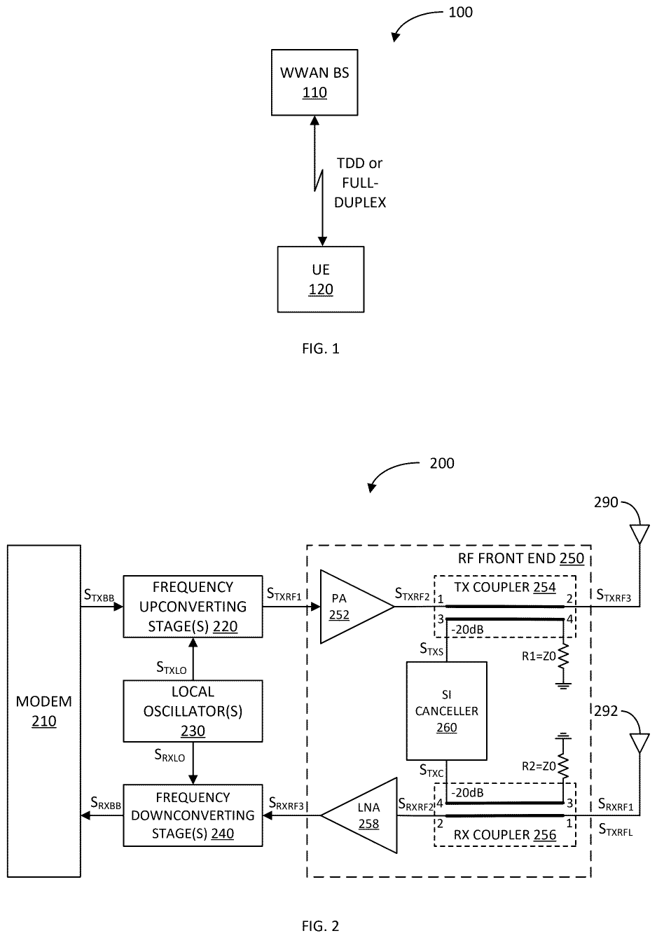

FIG. 1 illustrates a block diagram of an example wireless communication system 100 in accordance with an aspect of the disclosure. The wireless communication system 100 includes a wireless wideband area network (WWAN) base station (BS) 110 and a user equipment (UE) 120. The WWAN BS 110 and UE 120 may wirelessly communicate with each other in accordance with various protocols, such as New Radio (NR) 5^{th} or 6^{th} Generation (5G) or (6G), or other. Further, although a WWAN is used to exemplify the concepts described herein, it shall be understood that the concepts described herein may be applicable to wireless local area networks (WLANs) (e.g., WiFi), short distance area networks (e.g., Bluetooth), personal area networks, or ultra wideband (UWB) based wireless networks, etc.

In this example, the WWAN BS 110 and UE 120 may wirelessly communicate with each other using a time division duplex (TDD) communication link or a full-duplex (FD) communication link. A TDD communication link may include one or more time slots reserved for downlink signal reception (e.g., from the WWAN BS 110 to the UE 120), and other one or more time slots reserved for uplink signal transmission (e.g., from the UE 120 to the WWAN BS 110). For example, the wireless communication system 100 may use a “4D1U” TDD communication link, where there are four (4) slots for downlink signal reception per one (1) slot for uplink signal transmission. A drawback of such TDD communication link is that there is significant latency impacting the uplink signal transmission.

An alternative to a TDD communication link is a full-duplex (FD) communication link, where the downlink signal reception may occur at the same time as the uplink signal transmission using substantially similar frequencies (e.g., the same frequency band, overlapping frequency bands, or very close non-overlapping frequency bands (e.g., within five (5) percent bandwidth from each other)). Accordingly, the UE 120 may receive downlink signals from and transmit uplink signals to the WWAN BS 110 at the same time, basically eliminating the latency associated with a TDD communication link. However, a drawback of the FD communication link is that the transmitted uplink signal may leak into the receiver resulting in self-interference (SI) with the simultaneous reception of the received downlink signal. This is better explained with reference to the following example transceiver.

FIG. 2 illustrates a block/schematic diagram of an example transceiver 200 in accordance with another aspect of the disclosure. The transceiver 200 may be implemented in the UE 120, WWAN BS 110, or other wireless devices and/or equipment.

The transceiver 200 includes a modem 210, one or more frequency upconverting stages 220, one or more local oscillators (LOs) 230, one or more frequency downconverting stages 240, and a radio frequency front end (RFFE) 250. The RFFE 250, in turn, includes a power amplifier (PA) 252 and a transmit (Tx) coupler 254 including a transmitted port “2” coupled to a transmit (Tx) antenna 290. The RFFE 250 further includes a receive coupler 256 including an input port “1” coupled to a receive (Rx) antenna 292, and a low noise amplifier (LNA) 258. Additionally, the RFFE 250 includes a self-interference (SI) canceller (or cancellation circuit) 260 for cancelling an uplink transmit signal leaked into the receiver circuit of the transceiver 200.

With regard to transmission, the modem 210 is configured to generate a transmit (Tx) baseband (BB) signal S_{TXBB}. The one or more frequency upconverting stages 220 may be configured to frequency upconvert the transmit baseband signal S_{TXBB} to generate a first (intermediate) transmit (Tx) radio frequency (RF) signal S_{TXRF1} based on one or more transmit local oscillator signals S_{TXLO}, respectively. Although not shown, it shall be understood that the transceiver 200 may include a digital-to-analog converter (DAC) to convert the transmit BB signal S_{TXBB} into an analog signal. The PA 252 is configured to amplify the first Tx RF signal S_{TXRF1} to generate a second transmit RF signal S_{TXRF2}. The second Tx RF signal S_{TXRF2} propagates through the input port “1” and the transmitted port “2” of the transmit coupler 254 to provide a third transmit RF signal S_{TXRF3} (e.g., slightly less power than S_{TXRF2} due to the insertion loss (S21) of the transmit coupler 254, e.g., −0.27 decibel (dB)) to the transmit antenna 290 for wireless transmission to the WWAN BS 110.

The transmit coupler 254 is configured to generate a sample transmit RF signal S_{TXS} at a coupled port “3” (e.g., with a power level of substantially −20 dB compared to the second transmit signal S_{TXRF2}). The transmit coupler 254 includes an isolated port “4”, wherein a termination resistor R1=Z0 (e.g., Z0 may be a selected characteristic impedance, e.g., Z0=50Ω) is coupled between the isolated port “4” and a lower voltage rail (e.g., ground). The SI canceller 260 is configured to receive and process the sampled transmit signal S_{TXS} to generate a leaked transmit cancelling RF signal S_{TXC} to substantially remove a leaked transmit signal S_{TXRFL} (e.g., a portion of the third transmit RF signal leaking into the receiver of the transceiver 200) from the receiver circuit of the transceiver 200. The SI canceller 260 provides the leaked transmit cancelling RF signal S_{TXC} to a coupled port “4” of the receive coupler 256.

With regard to reception, the receive antenna 292 wirelessly picks up a first received RF signal S_{RXRF1} from the WWAN BS 110 and the leaked transmit RF signal S_{TXRFL} from the transmit antenna 290, and provides them (e.g., S_{RXRF1}+S_{TXRFL}) to an input port “1” of the receive coupler 256. The isolation between the transmit antenna 290 and the receive antenna 292 may be substantially −20 dB. The receive coupler 256 couples in the leaked transmit cancelling RF signal S_{TXC} via the coupled port “4” with substantially a −20 dB loss such that it combines with the first received RF signal S_{RXRF1} and the leaked transmit RF signal S_{TXRFL}. The SI canceller 260 configures the leaked transmit cancelling RF signal S_{TXC} to be substantially 180 degrees out-of-phase with and substantially the same power as the leaked transmit RF signal S_{TXRFL} such that cancellation of the leaked transmit RF signal S_{TXRFL} occurs in the receive coupler 256.

Accordingly, a second received RF signal S_{RXRF2} is provided to the LNA 258, which is substantially the same as the first received RF signal S_{RXRF1} with small losses due to propagation through the input port “1” and a transmitted port “2” of the receive coupler 256 (e.g., due to the insertion loss (S21) of the receive coupler 256). The receive coupler 256 includes an isolated port “3”, wherein a termination resistor R2=Z0 is coupled between the isolated port “3” and the lower voltage rail (e.g., ground). The LNA 258 amplifies the second received RF signal S_{RXRF2} to generate a third (amplified) received RF signal S_{RXRF3}.

The one or more frequency downconverting stages 240 may be configured to frequency downconvert the third receive RF signal S_{RXRF3} to generate a receive BB signal S_{RXBB} based on one or more receive local oscillator signals S_{RXLO}, respectively. Although not shown, it shall be understood that the transceiver 200 may include an analog-to-digital converter (ADC) to convert the receive BB signal S_{RXBB} into a digital signal. The modem 210 is configured to receive and process the receive BB signal S_{TXBB} to extract/recover data/information therein.

In this example, the couplers 254 and 256 have a coupling coefficient of substantially −20 dB so as not to impact the transmit RF signal S_{TXRF3} and the received RF signal S_{RXRF2}. However, such coupling coefficient provides some difficulties for the SI canceller 260. For example, the SI canceller 260 needs to provide a substantially +20 dB gain to the sampled transmit RF signal S_{TXS} to generate the leaked transmit cancelling RF signal S_{TXC} such that it has substantially the same power as the leaked transmit RF signal S_{TXRFL} for full cancellation in the received coupler 256.

This may not be desirable as it complicates the design of the SI canceller 260 to provide such signal gain (e.g., requiring active devices), which may distort the leaked transmit cancelling RF signal S_{TXC} due to non-linearity of the active devices. Further, the active devices of the SI canceller 260 also consume power. It would be preferred for the SI canceller 260 to be passive for ease of design, avoid signal distortion, and reduce power consumption of the transceiver 200.

Also, if the transceiver 200 is operated in a TDD mode of operation, there is no need for the SI canceller 260 as the transceiver 200 transmits an RF signal at a different (non-overlapping) time as it receives an RF signal. Accordingly, in TDD mode, it may be desirable for the SI canceller 260 to not disturb the transmit RF signal and the receive RF signal in TDD mode. However, in FD mode of operation, the SI canceller 260 may be needed to substantially cancel the transmit RF signal that has leaked into the receiver so as not to interfere with the reception of the receive RF signal.

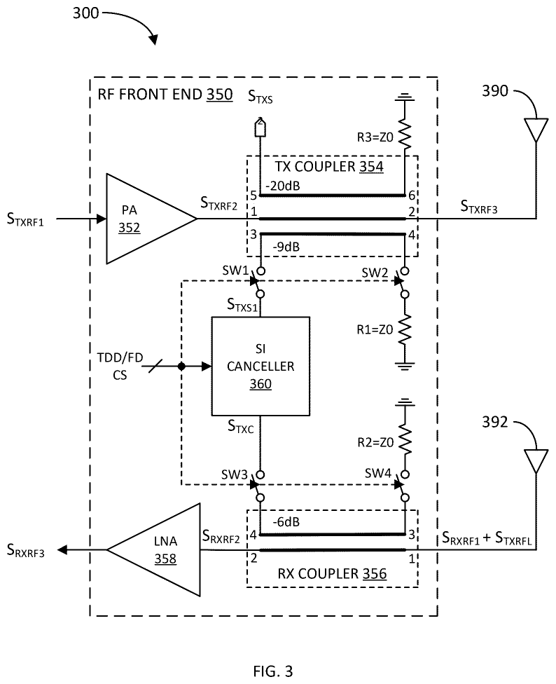

FIG. 3 illustrates a block/schematic diagram of an example radio frequency front end (RFFE) 300 in accordance with another aspect of the disclosure. Similarly, the RFFE 300 includes a PA 352, a transmit coupler 354 including a transmitted port “2” coupled to a transmit antenna 390, a receive coupler 356 including an input port “1” coupled to a receive antenna 392, an LNA 358, and an SI canceller 360.

In contrast to RFFE 250, the RFFE 300 includes: (1) a set of switching devices SW1-SW4, (2) the transmit coupler 354 may include two coupling components (levels or losses): a substantially −9 dB coupling component to provide a first sampled transmit RF signal S_{TXS1} to the SI canceller 360 and a substantially −20 dB coupling component to provide a second sampled transmit RF signal S_{TXS2} for other applications (e.g., testing, power monitoring and control, digital predistortion (DPD), etc.), and the receive coupler 356 provides a coupling coefficient of −6 dB. While the set of switching devices SW1-SW4 are described/illustrated as being separate and outside of SI canceller 360, they may be part of or integrated with the SI canceller 360, for example, by providing similar switching operations. The components of the RFFE 250 may be integrated into a single integrated circuit (IC) or chip, or may be implemented as a dedicated circuit including one or more ICs.

Although the transmit coupler 354 is described as including two integrated coupling components, it shall be understood that the RFFE 300 may include two separate transmit couplers between the PA 352 and the antenna 390. For example, first and second transmit couplers may be cascaded (e.g., coupled in series, or at different distances from the output of the PA 352) between the PA 352 and the antenna 390, where the first coupler may have a first coupling coefficient (e.g., −9 dB) and the second coupler may have second coupling coefficient (e.g., −20 dB) different than the first coupler. The first coupler may be selectively coupled to the SI canceller 360 based on a TDD or FD mode of operation.

The switching device SW1 is coupled between a first coupled port “3” of the transmit coupler 354 and an input of the SI canceller 360. The second switching device SW2 is coupled between a first isolated port “4” of the transmit coupler 354 and a termination resistor R1=Z0, wherein the termination resistor R1=Z0 is coupled between the second switching device SW2 and a lower voltage rail (e.g., ground). It shall be understood that the positions of the second switching device SW2 and termination resistor R1=Z0 may be swapped. The third switching device SW3 is coupled between an output of the SI canceller 360 and a coupled port “4” of the receive coupler 356. The switching device SW4 is coupled between an isolated port “3” of the receive coupler 356 and a termination resistor R2=Z0, wherein the termination resistor R2=Z0 is coupled between the fourth switching device SW4 and the lower voltage rail. It shall be understood that the positions of the fourth switching device SW4 and termination resistor R2=Z0 may be swapped. Further, the SI canceller 360 and the switching devices SW1-SW4 may be responsive to a TDD/FD mode control signal (CS). It shall be further understood that the termination resistors R1 and R2 may each be an impedance including a real part (e.g., resistance as shown) and/or an imaginary part (e.g., reactance).

In operation, via the TDD/FD mode control signal, the switching devices SW1-SW4 configure the RFFE 300 between TDD mode and full-duplex (FD) mode. In TDD mode, at least one of the switching devices SW1-2 and SW3-4 are OFF (or open) and in FD mode, the switching devices SW1-SW4 are ON (or closed). As discussed further herein, the TDD/FD mode control signal may also control or tune the SI canceller 360 to ensure substantially optimal signal cancellation of the leaked transmit RF signal S_{TXRFL} at the receive coupler 356. The couplers 354 and 356 may be configured with higher (asymmetrical) coupling coefficients (e.g., −9 dB and −6 dB, respectively) for leaked transmit RF signal S_{TXRFL} cancellation purpose. This allows the SI canceller 360 to be implemented with passive devices or minimum usage of active circuitry for ease of design, reduced signal distortion, and reduced power consumption, as previously discussed.

Accordingly, in FD mode, at least one of the turned-on switching devices SW1-SW2 enable the −9 dB coupling component of the transmit coupler 354 so as to provide the first sampled transmit RF signal S_{TXS1} to the SI canceller 360 with a −9 dB coupling coefficient, and at least one of the turned-on switching devices SW3-SW4 enable the receive coupler 356 to provide the leaked transmit cancelling RF signal S_{TXC} to the receive coupler 356 with a −6 dB coupling coefficient. This is a cumulative signal loss of −15 dB across the couplers 354 and 356. Assuming, as discussed with reference to transceiver 200, that the isolation between the antennas 390 and 392 is substantially −20 dB, this gives the SI canceller 360 a power headroom of five (5) dB for processing the first sampled RF signal S_{TXS1} to generate the leaked transmit cancelling RF signal S_{TXC}.

In TDD mode, the turned-off switching devices SW1-SW2 essentially disable the −9 dB coupling component of the transmit coupler 354 so as not to significantly affect (e.g., present losses to) the TDD transmit RF signal S_{TXRF3}. The turned-off switching devices SW3-SW4 disables the receive coupler 356 so as not to significantly affect the TDD receive signal S_{RXRF2}. With regard to the second coupling component (e.g., −20 dB) of the transmit coupler 354, the second sampled transmit signal S_{TXS2} is generated at a second coupled port “5”. The second coupling component may include a termination resistor R3=Z0 coupled between a second isolated port “6” and the lower voltage rail (e.g., ground).

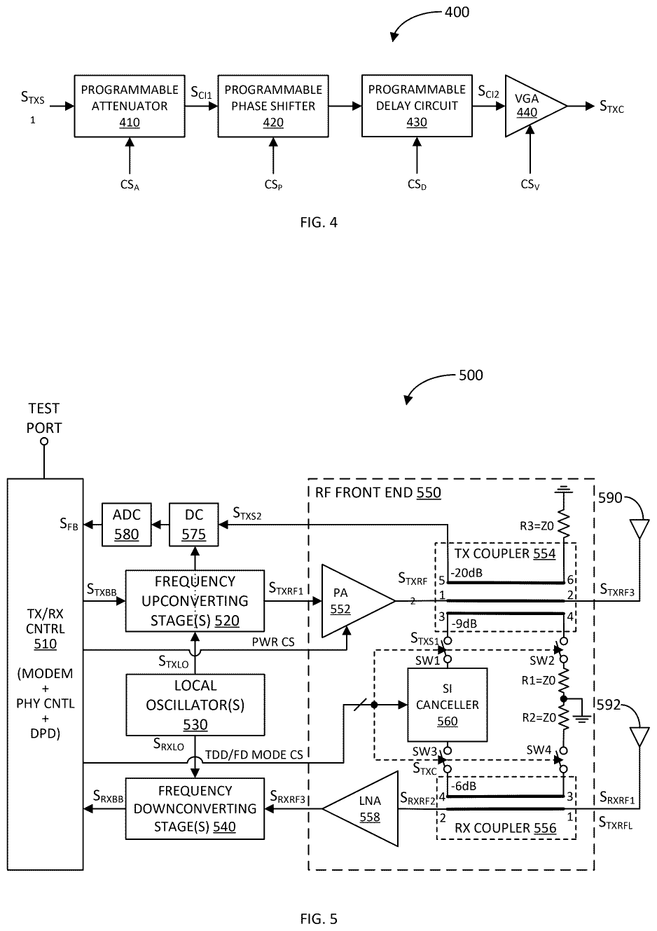

FIG. 4 illustrates a block diagram of an example self-interference (SI) canceller 400 in accordance with another aspect of the disclosure. The SI canceller 400 may be an example implementation of the SI canceller 360 previously discussed. As previously discussed, the SI canceller 400 is configured to receive the first sampled transmit RF signal S_{TXS1} to generate the leaked transmit cancelling RF signal S_{TXC} for cancelling the leaked transmit RF signal S_{TXRFL} at the receive coupler 356.

In particular, the SI canceller 400 may include a programmable attenuator 410, a programmable phase shifter 420, and/or a programmable delay circuit 430. The programmable attenuator 410 is configured to receive and attenuate the first sampled transmit RF signal S_{TXS1} based on a control signal CS_{A} to generate a first intermediate signal S_{CI1}. The programmable phase shifter 420 and/or the programmable delay circuit 430 may be configured to phase shift and/or delay the first intermediate signal S_{CI1} based on a control signal CS_{P} and/or a control signal CS_{D} to generate a second intermediate signal S_{CI2}. The SI canceller 400 may include a variable gain amplifier (VGA) 440 configured to amplify the second intermediate signal SCI₂ based on a control signal C_{SV} to generate the leaked transmit cancelling RF signal S_{TXC}. The control signals CS_{A}, CS_{P}, CS_{D}, and CS_{V} may also be components of the TDD/FD mode control signal. It shall be understood that the order of the programmable attenuator 410, programmable phase shifter 420, programmable delay circuit 430, and VGA 440 from input to output may be different. It shall be further understood that one or both of the programmable attenuator 410 and/or VGA 440 may be optional so as to provide a desired gain (e.g., S_{TXC}/S_{TXS1}) between the input and output of the SI canceller 400.

FIG. 5 illustrates a block diagram of another example transceiver 500 in accordance with another aspect of the disclosure. The transceiver 500 may be implemented in the UE 120, WWAN BS 110, or other wireless devices and/or equipment.

The transceiver 500 includes a transceiver (Tx/Rx) controller 510, one or more frequency upconverting stages 520, one or more local oscillators (LOs) 530, one or more frequency downconverting stages 540, a feedback downconverter (DC) 575, a feedback analog-to-digital converter 580, and a radio frequency front end (RFFE) 550. The RFFE 550, in turn, includes a power amplifier (PA) 552 and a transmit (Tx) coupler 554 including a transmitted port “2” coupled to a transmit (Tx) antenna 590. The RFFE 550 further includes a receive coupler 556 including an input port “1” coupled to a receive (Rx) antenna 592, and a low noise amplifier (LNA) 558. Additionally, the RFFE 550 includes a self-interference (SI) canceller (or cancellation circuit) 560 for cancelling an uplink transmit signal leaked into the receiver circuit of the transceiver 500 in a full-duplex (FD) mode of operation, and a set of switching devices SW1-SW4 for configuring the RFFE 550 between TDD and FD modes of operation.

The transceiver controller 510 may provide various operations including modem, physical layer control, and digital predistortion (DPD). With regard to modem transmission operation, the transceiver controller 510 is configured to generate a transmit (Tx) baseband (BB) signal S_{TXBB}. The one or more frequency upconverting stages 520 may be configured to frequency upconvert the transmit baseband signal S_{TXBB} to generate a first (intermediate) transmit (Tx) radio frequency (RF) signal S_{TXRF1} based on one or more transmit local oscillator signals S_{TXLO}, respectively. Although not shown, it shall be understood that the transceiver 500 may include a digital-to-analog converter (DAC) to convert the transmit BB signal S_{TXBB} into an analog signal. The PA 552 is configured to amplify the first Tx RF signal S_{TXRF1} to generate a second transmit RF signal S_{TXRF2}. The second Tx RF signal S_{TXRF2} propagates through the input port “1” and the transmitted port “2” of the transmit coupler 554 to provide a third transmit RF signal S_{TXRF3} (e.g., slightly lower power than S_{TXRF2}, e.g., −0.27 dB) to the transmit antenna 590 for wireless transmission to the WWAN BS 110.

The transmit coupler 554 includes a first coupling component configured to generate a first sample transmit RF signal S_{TXS1} at a first coupled port “3” (e.g., with a power level of substantially −9 dB compared to the second transmit signal S_{TXRF2}). The first switching device SW1 is coupled between the first coupled port “3” of the transmit coupler 554 and an input of the SI canceller 560. The transmit coupler 554 includes a first isolated port “4”, wherein the second switching device SW2 is coupled in series with a termination resistor R1=Z0 (e.g., Z0 may be a selected characteristic impedance, e.g., Z0=50Ω) between the first isolated port “4” and a lower voltage rail (e.g., ground).

In FD mode, the SI canceller 560 is configured to receive and process the first sampled transmit signal S_{TXS1} to generate a leaked transmit cancelling RF signal S_{TXC} to substantially remove a leaked transmit signal S_{TXRFL} from the receiver circuit of the transceiver 500. The SI canceller 560 provides the leaked transmit cancelling RF signal S_{TXC} to a coupled port “4” of the receive coupler 556 via the third switching device SW3.

With regard to reception, the receive antenna 592 wirelessly picks up a first received RF signal S_{RXRF1} from the WWAN BS 110 and a leaked transmit signal RF S_{TXRFL} from the transmit antenna 590, and provides them (e.g., S_{RXRF1}+S_{TXRFL}) to the input port “1” of the receive coupler 556. The isolation between the transmit antenna 590 and the receive antenna 592 may be substantially −20 dB. In FD mode, the receive coupler 556 couples in the leaked transmit cancelling RF signal S_{TXC} via the coupled port “4” with substantially a −6 dB loss such that it combines with the first received RF signal S_{RXRF1} and the leaked transmit RF signal S_{TXRFL}. The SI canceller 560 configures the leaked transmit cancelling RF signal S_{TXC} to be substantially 180 degrees out-of-phase with and substantially the same power as the leaked transmit RF signal S_{TXRFL} such that cancellation of the leaked transmit RF signal S_{TXRFL} occurs in the receive coupler 556.

Accordingly, a second received RF signal S_{RXRF2} is provided to the LNA 558, which is substantially the same as the first received RF signal S_{RXRF1} with small losses due to propagation through the input port “1” and a transmitted port “2” of the receive coupler 556. The receive coupler 556 includes an isolated port “3”, wherein the fourth switching device SW4 is coupled in series with a termination resistor R2=Z0 between the isolated port “3” and the lower voltage rail (e.g., ground). The LNA 558 amplifies the second received RF signal S_{RXRF2} to generate a third (amplified) received RF signal S_{RXRF3}.

The one or more frequency downconverting stages 540 may be configured to frequency downconvert the third receive RF signal S_{RXRF3} to generate a receive BB signal S_{TXBB} based on one or more receive local oscillator signals S_{RXLO}, respectively. Although not shown, it shall be understood that the transceiver 500 may include an analog-to-digital converter (ADC) to convert the receive BB signal S_{RXBB} into a digital signal. The transceiver controller 510 is configured to receive and process the receive BB signal S_{TXBB} to extract/recover data/information therein.

With regard to physical layer control, the transceiver controller 510 may be configured to generate a TDD/FD mode control signal (CS), which may be provided to the SI canceller 560 and the set of switching devices SW1-SW4. In response to the TDD/FD mode control signal indicating TDD mode of operation, the switching devices SW1-SW4 may be OFF (open) to effectively disable the −9 dB coupling component of the transmit coupler 554 and effectively disable the receive coupler 556. This may be done so that the transmit and receive couplers 554 and 556 do not significantly affect the TDD transmit signal S_{TXRF3} and the TDD receive signal S_{RXRF2}.

In response to the TDD/FD mode control signal indicating FD mode, the switching devices SW1-SW4 may be ON (closed) to enable the −9 dB coupling component of the transmit coupler 554 and enable the receive coupler 556. The TDD/FD mode control signal indicating FD mode may also tune (e.g., signal attenuation and phase shift) the SI canceller 560 so that the SI canceller 560 generates the leaked transmit cancelling signal RF S_{TXC}, based on the first sampled transmit RF signal S_{TXS1}, to achieve substantial cancellation of the leaked transmit RF signal S_{TXRFL} at the receive coupler 556.

With regard to other physical layer control and digital predistortion (DPD), the transmit coupler 554 further includes a second coupling component including the second coupled port “5” coupled to an input of the feedback downconverter 575 and a second isolated port “6”, wherein a termination resistor R3=Z0 is coupled between the second isolated port “6” and the lower voltage rail (e.g., ground). The second coupling component may be configured to produce a second sampled transmit RF signal S_{TXS2} with a coupling coefficient of, for example, substantially −20 dB compared to the second transmit RF signal S_{TXRF2}.

The feedback downconverter 575 is configured to frequency downconvert the second sampled transmit RF signal S_{TXS2} based on the one or more transmit LO signals S_{TXLO}, and the ADC 580 is configured to convert the downconverted signal into a digital feedback signal S_{FB}. The transceiver controller 510 may be configured to perform physical layer operation and DPD based on the digital feedback signal S_{FB}. For example, the transceiver controller 510 may be configured to generate a power control signal (CS) to set the gain/linearity operating region of the PA 552 based on the digital feedback signal S_{FB}. The transceiver controller 510 may digitally predistort the transmit BB signal S_{TXBB} to improve the linearization of the PA 552. The transceiver controller 510 may also provide the digital feedback signal S_{FB} to a test port for monitoring, testing, diagnostic, and/or purposes.

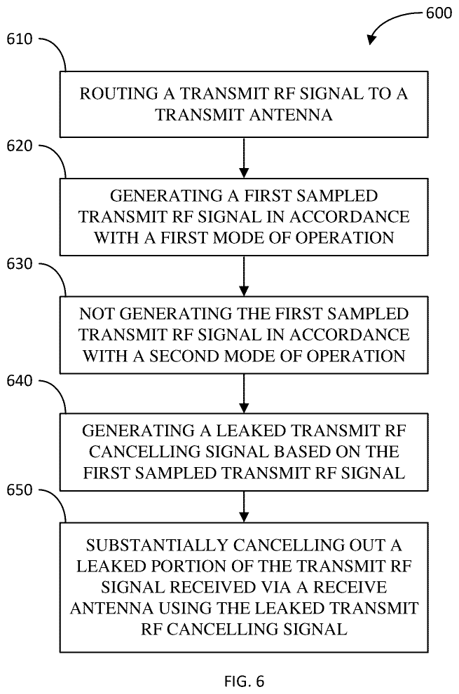

FIG. 6 illustrates a flow diagram of an example method 600 of cancelling a leaked portion of a transmit RF signal into a receiver in accordance with another aspect of the disclosure. The method 600 includes routing a transmit RF signal to a transmit antenna (block 610). Examples of means for routing a transmit RF signal to a transmit antenna includes any of transmit coupler 354 or 554. The method 600 further includes generating a first sampled transmit RF signal in accordance with a first mode of operation (block 620). Examples of means for generating a first sampled transmit RF signal in accordance with a first mode of operation includes any of the transmit coupler 354 or 554.

Additionally, the method 600 includes not generating the first sampled transmit RF signal in accordance with a second mode of operation (block 630). Examples of means for not generating the first sampled transmit RF signal in accordance with a second mode of operation include switching devices SW1-SW2 decoupling the transmit coupler 354 or 554 from the SI canceller 360 or 560, respectively. The method 600 includes generating a leaked transmit cancelling RF signal based on the first sampled transmit RF signal (block 640). Examples of means for generating a leaked transmit cancelling RF signal based on the first sampled transmit RF signal include any of the SI canceller 360 or 560. Further, the method 600 includes substantially cancelling out a leaked portion of the transmit RF signal received via a receive antenna using the leaked transmit cancelling RF signal (block 650). Examples of means for substantially cancelling out a leaked portion of the transmit RF signal received via a receive antenna using the leaked transmit cancelling RF signal include any of the receive coupler 356 or 556.

The following provides an overview of aspects of the present disclosure:

Aspect 1: A wireless communication apparatus comprising: a power amplifier (PA); a transmit coupler including a first input port coupled to an output of the PA and a first coupled port; a self-interference (SI) canceller; a first switching device coupled between the first coupled port of the transmit coupler and an input of the SI canceller; a low noise amplifier (LNA); a receive coupler including a transmitted port coupled to an input of the LNA and a coupled port; and a second switching device coupled between an output of the SI canceller and the coupled port of the receive coupler.

Aspect 2: The wireless communication apparatus of aspect 1, wherein the first and second switching devices are in a closed state in response to a transceiver mode control signal indicating a full-duplex (FD) mode of operation.

Aspect 3: The wireless communication apparatus of aspect 1 or 2, wherein the first and second switching devices are in an open state in response to a transceiver mode control signal indicating a time division duplex (TDD) mode of operation.

Aspect 4: The wireless communication apparatus of any one of aspects 1-3, wherein the SI canceller comprises: a programmable attenuator and/or a variable gain amplifier (VGA); and a programmable phase shifter and/or a programmable delay circuit coupled in series with the programmable attenuator and/or the VGA between the input and the output of the SI canceller, wherein the programmable attenuator and/or the VGA and the programmable phase shifter and/or the programmable delay circuit are responsive to one or more control signals.

Aspect 5: The wireless communication apparatus of any one of aspects 1-4, wherein the transmit coupler further comprises a second coupled port.

Aspect 6: The wireless communication apparatus of any one of aspects 1-5, further comprising: a first termination impedance; a third switching device coupled between a first isolated port and the first termination impedance or the first termination impedance coupled between the first isolated port and the third switching device; a second termination impedance; and a fourth switching device coupled between a second isolated port of the receive coupler and the second termination impedance or the second termination impedance coupled between the second isolated port and the fourth switching device.

Aspect 7: The wireless communication apparatus of claim 1, wherein the SI canceller is integrated with the first and second switching devices.

Aspect 8: A transceiver, comprising: a power amplifier configured to generate a transmit radio frequency (RF) signal; a transmit coupler configured to route the transmit RF signal to a transmit antenna, wherein the transmit coupler is configured to be selectively enabled to generate a first sampled transmit RF signal in accordance with a first mode of operation, and wherein the transmit coupler is configured to be selectively disabled in accordance with a second mode of operation; a self-interference (SI) canceller configured to generate a leaked transmit cancelling RF signal based on the first sampled transmit RF signal; and a receive coupler configured to route a receive RF signal from a receive antenna to a low noise amplifier (LNA), wherein the receive coupler is configured to substantially cancel out a leaked portion of the transmit RF signal using the leaked transmit cancelling RF signal.

Aspect 9: The transceiver of aspect 8, wherein the first mode of operation includes a full-duplex (FD) mode of operation.

Aspect 10: The transceiver of aspect 8 or 9, wherein the second mode of operation includes a time division duplex (TDD) mode of operation.

Aspect 11: The transceiver of any one of aspects 8-10, further comprising a first switching device coupled between a coupled port of the transmit coupler and an input of the SI canceller, wherein the first switching device is configured to be closed in accordance with the first mode of operation, and open in accordance with the second mode of operation.

Aspect 12: The transceiver of aspect 11, further comprising a second switching device coupled between an isolated port of the transmit coupler and a termination impedance, wherein the termination impedance is coupled between the second switching device and a lower voltage rail, and wherein the second switching device is configured to be closed in accordance with the first mode of operation, and open in accordance with the second mode of operation.

Aspect 13: The transceiver of aspect 12, wherein the first mode of operation comprises a full-duplex (FD) mode of operation, and the second mode of operation comprises a time division duplex (TDD) mode of operation.

Aspect 14: The transceiver of any one of aspects 8-13, further comprising a first switching device coupled between an output of the SI canceller and a coupled port of the receive coupler, wherein the first switching device is configured to be closed in accordance with the first mode of operation, and open in accordance with the second mode of operation.

Aspect 15: The transceiver of aspect 14, further comprising a second switching device coupled between an isolated port of the receive coupler and a termination impedance, wherein the termination impedance is coupled between the second switching device and a lower voltage rail, and wherein the second switching device is configured to be closed in accordance with the first mode of operation, and open in accordance with the second mode of operation.

Aspect 16: The transceiver of aspect 15, wherein the first mode of operation comprises a full-duplex (FD) mode of operation, and the second mode of operation comprises a time division duplex (TDD) mode of operation.

Aspect 17: The transceiver of any one of aspects 8-16, wherein the transmit coupler comprises: a first coupler component configured to generate the first sampled transmit RF signal with a first coupling loss; and a second coupler component configured to generate a second sampled transmit RF signal with a second coupling loss.

Aspect 18: The transceiver of aspect 17, wherein a cumulative loss of the first coupling loss and the second coupling loss is less than an isolation between the transmit antenna and the receive antenna.

Aspect 19: The transceiver of aspect 17 or 18, further comprising a transceiver controller configured to control a gain of the power amplifier based on the second sampled transmit RF signal.

Aspect 20: The transceiver of any one of aspects 17-19, further comprising: a modem configured to generate a transmit baseband signal; a digital predistortion (DPD) module configured to digitally predistort the transmit baseband signal based on the second sampled transmit RF signal; and one or more frequency upconverting stages configured to frequency upconvert the predistorted transmit baseband signal to generate an intermediate transmit RF signal, wherein the power amplifier is configured to amplify the intermediate transmit RF signal to generate the transmit RF signal.

Aspect 21: A method, comprising: routing a transmit RF signal to a transmit antenna; generating a first sampled transmit RF signal in accordance with a first mode of operation; not generating the first sampled transmit RF signal in accordance with a second mode of operation; generating a leaked transmit cancelling RF signal based on the first sampled transmit RF signal; and substantially cancelling out a leaked portion of the transmit RF signal received via a receive antenna using the leaked transmit cancelling RF signal.

Aspect 22: The method of aspect 21, wherein the first mode of operation includes a full-duplex (FD) mode of operation.

Aspect 23: The method of aspect 21 or 22, wherein the second mode of operation includes a time division duplex (TDD) mode of operation.

Aspect 24: An apparatus, comprising: means for routing a transmit RF signal to a transmit antenna; means for generating a first sampled transmit RF signal in accordance with a first mode of operation; means for not generating the first sampled transmit RF signal in accordance with a second mode of operation; means for generating a leaked transmit cancelling RF signal based on the first sampled transmit RF signal; and means for substantially cancelling out a leaked portion of the transmit RF signal received via a receive antenna using the leaked transmit cancelling RF signal.

Aspect 25: A wireless communication apparatus, comprising: a power amplifier (PA); a first transmit coupler coupled to an output of the PA, the first transmit coupler having a first level of coupling; a second transmit coupler coupled to the output of the PA, the second transmit coupler having a second level of coupling different than the first level of coupling; a low noise amplifier (LNA); a receive coupler coupled to an input of the LNA; and a self-interference cancellation circuit selectively coupled to the second transmit coupler and selectively coupled to the receive coupler.

Aspect 26: The wireless communication apparatus of aspect 25, wherein the second level of coupling is higher than the first level of coupling.

Aspect 27: The wireless communication apparatus of aspect 26 or 27, further comprising a controller configured to selectively couple the self-interference cancellation circuit to the second transmit coupler and the receive coupler based on a time division duplex (TDD) mode of operation or a full-duplex (FD) mode of operation.

The previous description of the disclosure is provided to enable any person skilled in the art to make or use the disclosure. Various modifications to the disclosure will be readily apparent to those skilled in the art, and the generic principles defined herein may be applied to other variations without departing from the scope of the disclosure. Thus, the disclosure is not intended to be limited to the examples described herein but is to be accorded the widest scope consistent with the principles and novel features disclosed herein.

What is claimed:

1. A wireless communication apparatus, comprising:
a power amplifier (PA);
a transmit coupler including a first input port coupled to an output of the PA and a first coupled port;
a self-interference (SI) canceller;
a first switching device coupled between the first coupled port of the transmit coupler and an input of the SI canceller;
a low noise amplifier (LNA);
a receive coupler including a transmitted port coupled to an input of the LNA and a coupled port; and
a second switching device coupled between an output of the SI canceller and the coupled port of the receive coupler.

2. The wireless communication apparatus of claim 1, wherein the first and second switching devices are in a closed state in response to a transceiver mode control signal indicating a full-duplex (FD) mode of operation.

3. The wireless communication apparatus of claim 1, wherein the first and second switching devices are in an open state in response to a transceiver mode control signal indicating a time division duplex (TDD) mode of operation.

4. The wireless communication apparatus of claim 1, wherein the SI canceller comprises:
a programmable attenuator and/or a variable gain amplifier (VGA); and
a programmable phase shifter and/or a programmable delay circuit coupled in series with the programmable attenuator and/or the VGA between the input and the output of the SI canceller, wherein the programmable attenuator and/or the VGA and the programmable phase shifter and/or the programmable delay circuit are responsive to one or more control signals.

5. The wireless communication apparatus of claim 1, wherein the transmit coupler further comprises a second coupled port.

6. The wireless communication apparatus of claim 1, further comprising:
a first termination impedance;
a third switching device coupled between a first isolated port and the first termination impedance or the first termination impedance coupled between the first isolated port and the third switching device;
a second termination impedance; and
a fourth switching device coupled between a second isolated port of the receive coupler and the second termination impedance or the second termination impedance coupled between the second isolated port and the fourth switching device.

7. A transceiver, comprising:
a power amplifier configured to generate a transmit radio frequency (RF) signal;
a transmit coupler configured to route the transmit RF signal to a transmit antenna, wherein the transmit coupler is configured to be selectively enabled to generate a first sampled transmit RF signal in accordance with a first mode of operation, and wherein the transmit coupler is configured to be selectively disabled in accordance with a second mode of operation;
a self-interference (SI) canceller configured to generate a leaked transmit cancelling RF signal based on the first sampled transmit RF signal; and
a receive coupler configured to route a receive RF signal from a receive antenna to a low noise amplifier (LNA), wherein the receive coupler is configured to substantially cancel out a leaked portion of the transmit RF signal using the leaked transmit cancelling RF signal.

8. The transceiver of claim 7, wherein the first mode of operation includes a full-duplex (FD) mode of operation.

9. The transceiver of claim 7, wherein the second mode of operation includes a time division duplex (TDD) mode of operation.

10. The transceiver of claim 7, further comprising a first switching device coupled between a coupled port of the transmit coupler and an input of the SI canceller, wherein the first switching device is configured to be closed in accordance with the first mode of operation, and open in accordance with the second mode of operation.

11. The transceiver of claim 10, further comprising a second switching device coupled between an isolated port of the transmit coupler and a termination impedance, wherein the termination impedance is coupled between the second switching device and a lower voltage rail, and wherein the second switching device is configured to be closed in accordance with the first mode of operation, and open in accordance with the second mode of operation.

12. The transceiver of claim 11, wherein the first mode of operation comprises a full-duplex (FD) mode of operation, and the second mode of operation comprises a time division duplex (TDD) mode of operation.

13. The transceiver of claim 7, further comprising a first switching device coupled between an output of the SI canceller and a coupled port of the receive coupler, wherein the first switching device is configured to be closed in accordance with the first mode of operation, and open in accordance with the second mode of operation.

14. The transceiver of claim 13, further comprising a second switching device coupled between an isolated port of the receive coupler and a termination impedance, wherein the termination impedance is coupled between the second switching device and a lower voltage rail, and wherein the second switching device is configured to be closed in accordance with the first mode of operation, and open in accordance with the second mode of operation.

15. The transceiver of claim 14, wherein the first mode of operation comprises a full-duplex (FD) mode of operation, and the second mode of operation comprises a time division duplex (TDD) mode of operation.

16. The transceiver of claim 7, wherein the transmit coupler comprises:
a first coupler component configured to generate the first sampled transmit RF signal with a first coupling loss; and
a second coupler component configured to generate a second sampled transmit RF signal with a second coupling loss.

17. The transceiver of claim 16, wherein a cumulative loss of the first coupling loss and the second coupling loss is less than an isolation between the transmit antenna and the receive antenna.

18. The transceiver of claim 16, further comprising a transceiver controller configured to control a gain of the power amplifier based on the second sampled transmit RF signal.

19. The transceiver of claim 16, further comprising:
a modem configured to generate a transmit baseband signal;
a digital predistortion (DPD) module configured to digitally predistort the transmit baseband signal based on the second sampled transmit RF signal; and
one or more frequency upconverting stages configured to frequency upconvert the predistorted transmit baseband signal to generate an intermediate transmit RF signal, wherein the power amplifier is configured to amplify the intermediate transmit RF signal to generate the transmit RF signal.

20. A method, comprising:
routing a transmit RF signal to a transmit antenna;
generating a first sampled transmit RF signal in accordance with a first mode of operation;
not generating the first sampled transmit RF signal in accordance with a second mode of operation;
generating a leaked transmit cancelling RF signal based on the first sampled transmit RF signal; and
substantially cancelling out a leaked portion of the transmit RF signal received via a receive antenna using the leaked transmit cancelling RF signal.

21. The method of claim 20, wherein the first mode of operation includes a full-duplex (FD) mode of operation.

22. The method of claim 20, wherein the second mode of operation includes a time division duplex (TDD) mode of operation.

23. A wireless communication apparatus, comprising:
a power amplifier (PA);
a first transmit coupler coupled to an output of the PA, the first transmit coupler having a first level of coupling;
a second transmit coupler coupled to the output of the PA, the second transmit coupler having a second level of coupling different than the first level of coupling;
a low noise amplifier (LNA);
a receive coupler coupled to an input of the LNA; and
a self-interference cancellation circuit selectively coupled to the second transmit coupler and selectively coupled to the receive coupler.

24. The wireless communication apparatus of claim 23, wherein the second level of coupling is higher than the first level of coupling.

25. The wireless communication apparatus of claim 23, further comprising a controller configured to selectively couple the self-interference cancellation circuit to the second transmit coupler and the receive coupler based on a time division duplex (TDD) mode of operation or a full-duplex (FD) mode of operation.
